(19) United States
(12) Patent Application Publication
(10) Pub. No.: US 2026/0252060 A1
(43) Pub. Date: Aug. 27, 2026

(54) METHOD FOR COMMISSIONING SENSORS AND/OR ACTUATORS IN INDUSTRIAL PLANTS

(71) Applicant: ifm electronic gmbh, Essen (DE)

(72) Inventors: Benno Kathan, Kressbronn (DE); Marius Bock, Friedrichshafen (DE)

(73) Assignee: ifm electronic gmbh, Essen (DE)

(21) Appl. No.: 19/545,839

(22) Filed: Feb. 20, 2026

(30) Foreign Application Priority Data
Feb. 25, 2025 (DE) 102025107024.5

(51) Int. Cl. G05B 19/418; B41J 3/407

(52) U.S. Cl. CPC G05B 19/41805; B41J 3/4075

(57) ABSTRACT

A method for commissioning sensors and/or actuators in industrial plants. The use of a mobile application and AI algorithms automates and accelerates the commissioning of sensors and actuators. The application determines, based on a photo, setpoints and limits which are transferred to a cloud instance in order to create preconfigured rules for warnings and alarms. This leads to optimized monitoring and increases plant availability and efficiency.

### CROSS-REFERENCE TO RELATED APPLICATIONS

This application claims priority to German application DE 102025107024.5, filed Feb. 25, 2025, the disclosure of which is incorporated herein by reference in its entity.

The invention relates to a method for commissioning sensors and/or actuators in industrial plants.

The commissioning and monitoring of plants is a necessary and crucial step for subsequent efficiency. However, this process is often time-consuming and requires specialized technical and machine knowledge.

The object of the invention is to significantly simplify and accelerate this process.

This object is achieved by a method having the features of claim 1. Advantageous embodiments of the invention are specified in the dependent claims.

The invention provides a method for commissioning sensors and/or actuators in industrial plants by means of a mobile application. This application allows for the quick and efficient commissioning of sensors, including wireless sensors, and/or actuators by means of a smartphone or tablet. According to the invention, the method comprises the following method steps:
providing the application: a mobile application is provided for commissioning the sensors or actuators.
taking a photo: the user takes a photo of the plant by means of the mobile application.
determining setpoints and limits: AI algorithms analyze the photo and determine the plant's setpoints and limits, for example for speed, current, and vibration.
transferring to the cloud: the determined setpoints and limits are automatically transferred to the user's cloud instance.
preconfiguring rules: based on the transferred data, rules for warnings and alarms are preconfigured.

An advantageous further development of the invention provides that the mobile application has an interface for connecting to a label printer in order to print a label displaying the IP address and name of the sensor. The user then affixes the label to the sensor.

In a further advantageous embodiment of the invention, the mobile application automatically determines the installation location data via GPS or WLAN in order to store this data in the cloud or to comply with local regulations, such as legal requirements.

A further advantageous embodiment of the invention provides that the mobile application generates a dashboard displaying a photo of the plant, its location, and widgets for monitoring machine data, thus increasing user-friendliness.

The advantages of the invention include, firstly, that the commissioning process for the sensors is accelerated without manual configuration, resulting in time saved. Furthermore, user-friendliness is increased because the commissioning process is more intuitive and automated, making it easy for users without specialized knowledge to carry out, and the commissioning engineer no longer needs any prior knowledge of the plant as a result of AI support. Finally, the invention also allows for optimized plant monitoring, as the automated determination of plant parameters allows for the early detection and resolution of problems.

The invention is explained in more detail below using exemplary embodiments with reference to the drawings.

In the drawings, shown schematically:

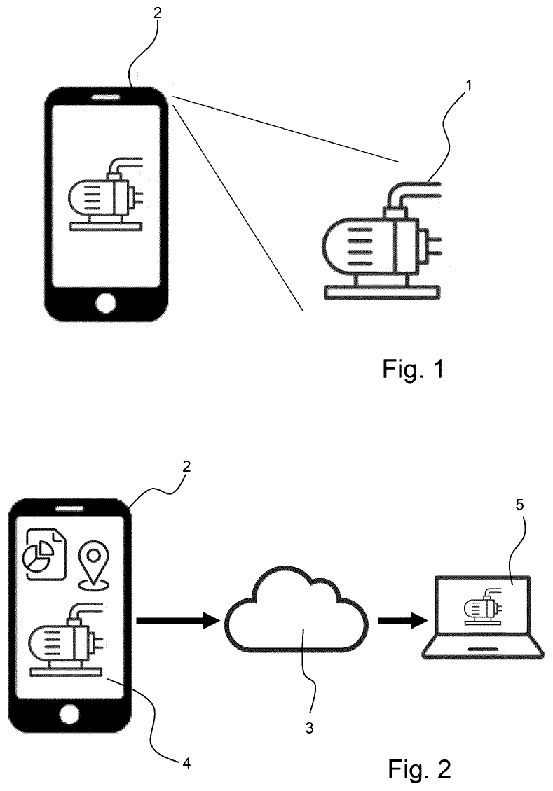

FIG. 1 shows taking a photo of a sensor or actuator by means of a mobile application, and

FIG. 2 shows connecting the mobile application to a cloud instance.

In the following description of the preferred embodiments, the same reference signs denote the same or comparable components.

A mobile application 2 provides users with a way to quickly and efficiently commission sensors 1—including wireless sensors—or actuators 1 in industrial plants by means of a smartphone or tablet. FIG. 1 shows a pump as an example of an actuator 1 and thus indirectly also of a sensor 1. By means of a smartphone or tablet 2, a photo of the sensor or actuator 1 or of the entire plant is taken. The integration of AI algorithms allows a broad search of the internet and databases based on the photo of the plant. This allows setpoints and limits of the machine to be determined for, for example, speed, current, and vibration. By simultaneously determining the installation location data via GPS or WLAN, it is also possible to comply with local regulations, such as legal requirements.

FIG. 2 shows connecting the mobile application 2 to a user's cloud instance 3. This allows setpoints and limits to be automatically transferred to the condition monitoring system, symbolized by a laptop 5, and rules for warnings and alarms to be preconfigured. In addition, the mobile application 2 can feature a dashboard 4 displaying a photo of the plant, its location, and widgets for monitoring machine data.

1. A method for commissioning sensors and/or actuators in industrial plants, comprising the steps of:
a. providing a mobile application for commissioning the sensors and/or actuators,
b. taking a photo of the plant by means of the mobile application,
c. determining, based on the photo taken, the plant's setpoints and limits by means of AI algorithms,
d. transferring the determined setpoints and limits to the user's cloud instance,
e. preconfiguring rules for warnings and alarms based on the transferred setpoints and limits.

2. The method according to claim 1, wherein the sensors are wireless sensors.

3. The method according to claim 1, wherein the mobile application has an interface for connecting to a label printer in order to print a label displaying the IP address and name of the sensor or actuator.

4. The method according to claim 1, wherein the mobile application automatically determines the installation location data via GPS or WLAN.

5. The method according to claim 1, wherein the mobile application generates a dashboard displaying a photo of the plant, its location, and widgets for monitoring machine data.

6. The method according to claim 1, wherein the mobile application transfers the photo documentation of the installation location and the selected device name to the user's cloud instance.
